(19) United States
(12) Patent Application Publication
(10) Pub. No.: US 2006/0036762 A1
(43) Pub. Date: Feb. 16, 2006

(54) System and method for automatic path generation in a computer network

(76) Inventors: Sravan Vadlakonda, Sunnyvale, CA (US); Naomi Ben-Ayoun, Sunnyvale, CA (US); Khanh Hoang, San Jose, CA (US)

Correspondence Address: Edward C. Kwok;MacPHERSON KWOK CHEN & HEID LLP, 1762 Technology Drive, Suite 226, San Jose, CA, 95110, US

(21) Appl. No.: 10/917,184

(22) Filed: Aug. 10, 2004

(51) Int. Cl. G06F 15/173

(52) U.S. Cl. 709/238

(57) ABSTRACT

A method and a system optimize the performance of an automatic path generation algorithm on a computer network. The system may include routers in the computer network configured into regions according to geographical locations, with some routers being designated inter-region routers in each region. The inter-region routers may be organized to be interconnected in a highly redundant manner (e.g., a full mesh) to ensure connectivity among the regions. Within such a network, when a path is required between routers in different regions, a processor applies the automatic path generation algorithm to: (a) the network segment in the region of the source router to generate a first set of paths, (b) the network segment of the inter-region routers to generate a second set of paths; and (c) the network segment of the destination router to generate a third set of paths, These set of paths are then combined to provide a set of paths between the source and destination routers. In addition, each router within each region may be further assigned a numerical rank indicative of a distance between the router and an inter-region router within the same region. In such a system, when a path is required between routers of the same region, the automatic path generation algorithm may be applied on a network segment pruned to include only routers with within a certain range of ranks.

### BACKGROUND OF THE INVENTION

1. Field of the Invention

The present invention relates to automatically finding paths in a network. In particular, the present invention relates to optimizing an automatic path generation algorithm in a computer network.

2. Discussion of the Related Art

The Automatic Path Generation (APG) algorithm computes paths between a source node and a destination node in a computer network, subject to a set of constraints, while minimizing the hops between the source node and the destination node. In a computer network, a hop count captures the network cost, as it measures the number of links over which network resources are used. If fewer links are used, the amount of bandwidth that is allocated for the path is lesser, resulting in a more efficient bandwidth usage in the entire network.

Under the APG algorithm, an exhaustive breadth-first search is used to evaluate paths between the source node and the destination node. Beginning with the source node as the current node, each node that is connected to the source node is identified as nodes having a hop count of one. Each identified node with a hop count of one is assigned in turn as a current node to repeat this procedure to identify nodes that are connected to it by a link. These nodes that are now two hops away from the source node are nodes with a hop count of two. This procedure is repeated iteratively in the same manner for nodes of successively greater hop counts. At every step, if the current node is the destination node, if it is a node that is already identified in a previously step, or if the hop count equals to a specified maximum, evaluation is complete as to that current node. Where more than a simple hop count is used as a cost of the path, the cost associated with each link in a path can be evaluated according to a set of constraints. Some typical constraints are the available bandwidth in the link and the estimated utilization of that bandwidth at the time of evaluation. Suitable algorithms for constrained path evaluation include the Dijstra algorithm (See, E. W. Dijkstra, “A note on two problems in connection with graphs,” Numerische Mathematik 1 (1959), 269-271.) and any of the radius based algorithms. In this manner, a set of paths, including the shortest path (i.e., the path with the least cost), may be identified. These algorithms can be used in conjunction with numerous network services, such as private virtual network (VPN) and multi-protocol label switching (MPLS) services.

The APG algorithm performs favorably for a medium size network (i.e., a network with less than 1000 nodes). However, as the algorithm does not take into account the placement or location of a given node in the network, as the number of nodes increases, both the complexity of the computation and the storage required for applying the algorithm to the network increase exponentially.

Thus, an optimized APG algorithm suitable for use in larger networks is desired.

### SUMMARY

The present invention provides a method and a system organized to optimize the performance of an automatic path generation algorithm on a computer network. According to one embodiment of the present invention, the system may include routers in the computer network configured into regions according to geographical locations, with one or more routers in each region being designated inter-region router or routers. The inter-region routers each have an interface with a router of another region. The inter-region routers may be organized to be interconnected in a highly redundant manner (e.g., a full mesh) to ensure connectivity among the regions. Within such a network, when a path is required between routers in different regions, a processor applies the automatic path generation algorithm independently to: (a) the network segment in the region of the source router to generate a first set of paths, (b) the network segment of the inter-region routers to generate a second set of paths; and (c) the network segment of the destination router to generate a third set of paths, These set of paths are then combined to provide a set of paths between the source and destination routers.

According to one embodiment of the present invention, each router within each region may be further assigned a numerical rank indicative of a distance between the router and an inter-region router within the same region. The numerical rank may be related, for example, to a hop count between the router and an inter-region router. In such a system, when a path is required between routers of the same region, the automatic path generation algorithm may be applied on a network segment pruned to include only routers with a rank greater than or equal to a predetermined numerical rank. One choice of such a network segment excludes the inter-region routers. Such a network segment may be organized topologically as a tree.

The present invention is applicable to an autonomous system with “backbone” connectivity for a wide area computer network and edge routers to which customer equipment may connect.

According to one embodiment of the present invention, the automatic path generation algorithm may include a path evaluation algorithm based on cost constraints, such as bandwidth availability or utilization factor.

The present invention is better understood upon consideration of the detailed description below and the accompanying drawings.

### BRIEF DESCRIPTION OF THE DRAWINGS

FIG. 1 illustrates network 100, which is implemented as a hierarchy, in accordance with one embodiment of the present invention.

### DETAILED DESCRIPTION OF THE PREFERRED EMBODIMENTS

The present invention takes advantage of favorable performance of the APG algorithm in medium size networks by dividing a large network into smaller network segments each of a size that the APG algorithm can be independently and favorably applied.

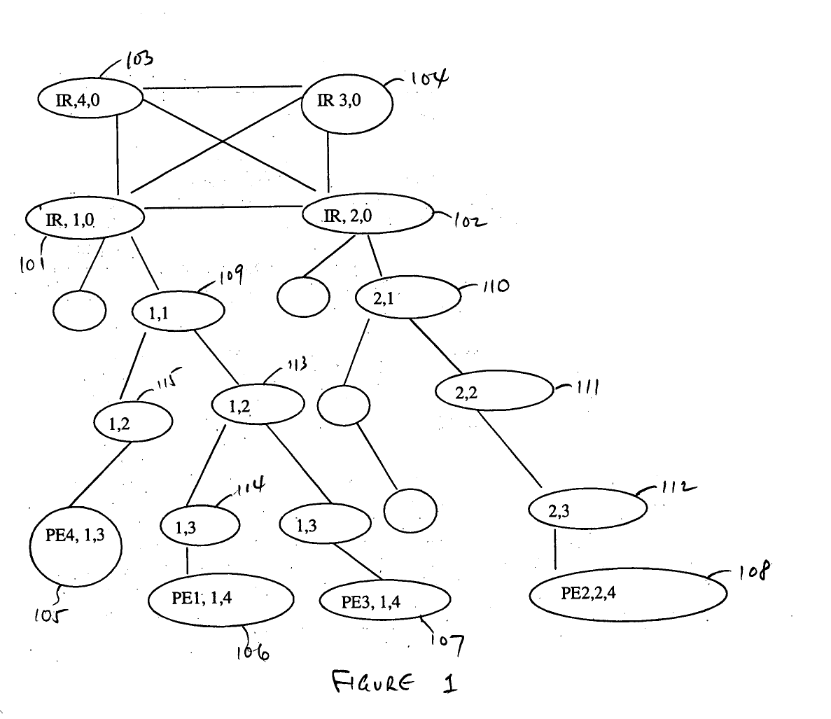

In many networks, such as the autonomous systems of service providers having “backbone” connectivity, the network may be implemented topologically as a hierarchy. At the top of the hierarchy are highly redundant core switches or routers, which haul the traffic between geographically disparate areas. One implementation divides the network into geographical regions (e.g., the network is divided into North America, Europe, Asia and other regions), with the regions interconnected with each other in a highly redundant, fully meshed fashion, so that no region would become an island due to the failures of a few links. FIG. 1 illustrates network 100, which is implemented as such a hierarchy. As shown in FIG. 1, the core of network 100 includes a highly redundant network of inter-region (IR) routers 101-104, with other nodes that are located further away from the core of the IR nodes forming a substantially tree topology. Nodes 105-108, which are the leaves of the trees, may be provider edge (PE) routers. PE routers interface with customer equipment as connection points into the provider network. An IR node interfaces with nodes of two or more different regions.

In FIG. 1, each node represents a router that is associated with a segment of network 100. Each node is assigned a region identification R, which is assigned at the time it is configured. For example, PE routers 105-107 of FIG. 1 are configured to region 1, and therefore each router has a regional identification of 1. Similarly, PE router 108 is configured to region 2. In accordance with one embodiment of the present invention, each node is also assigned a “rank” in the network. The rank of each node is determined at configuration time by the minimum hop count between it and an IR device of the same region identification. Thus, as shown in FIG. 1, PE router 105 has a rank of 3, and PE routers 105-107 each have a rank of 4. Naturally, the rank of each IR router is zero. In FIG. 1, each node is labeled by a tuple (R, rank), indicating its region identification and rank, respectively. Whenever a router is added into the network segment of a region, the rank of each router within the region is re-determined to ensure consistency.

According to one embodiment of the present invention, when a set of paths is required between a source node and a destination node, path evaluation is carried out according to the region assignments of the source and destination nodes. If the source node and the destination node belong to different regions, the APG algorithm is applied to each of the following network segments: (a) between the source node and the IR router or routers in the same region as the source node; (b) among the IR routers interfaced with the regions of the source and destination nodes; and (c) between the destination node and the IR router or routers of the same region as the destination node. Thus, for example, the total number of paths between source node 105 and destination node 108 is the product of S₁, S₂, and S₃, where S₁, S₂, and S₃ are, respectively, the number of paths discovered in network segments (a) between source PE router 105 and IR router 101, (b) between IR router 101 and IR router 102 and (c) between IR router 102 and destination router 108. Of course, within each network segment, any suitable kind of path evaluation algorithms may be used (e.g., Dijkstra, or any of the radius-based algorithms), and different network segments may use different evaluation algorithms, if appropriate. These algorithms can be used to support numerous services, such as VPN and MPLS services. Further, the APG algorithms can be applied to each network segment independently and in a distributed fashion (i.e., each network segment can be evaluated on a separate processor), and the results are combined to identify the individual paths.

When evaluating paths between two routers belonging to the same region, the applicable network segment may be bounded by the region of these routers (i.e., very infrequently can a more favorable path be found involving network segments outside of the region). One approach to further prune the search space for the APG algorithm is to involve only routers having a numerically higher rank in the search. For example, for a coarse calculation, it may be possible to involve all routers in the region. For a finer calculation, however, one may elect to include only routers having a rank numerically greater or equal to one (i.e., excluding the IR device) in the path evaluation. Restricting the network segment for application of the APG algorithm to routers having a rank that is an even higher numerical value will further reduce the network segment to which the APG algorithm is applied, and thus further optimize the performance of the APG algorithm.

The detailed description is provided to illustrate the specific embodiments of the present invention and is not intended to be limiting. Numerous modifications and variations within the scope of the invention are possible. The present invention is set forth in the following claims.

I claim:

1. A method for optimizing the performance of an automatic path generation algorithm on a computer network, comprising:
grouping routers in the computer network into regions according to geographical locations and designating a number of routers in each region having an interface with a router of another region as inter-region routers; and
when a path is required between a first router in a first region and a second router in a second region:
applying the automatic path generation algorithm to: (a) the network segment including routers in the first region to generate a first set of paths, (b) the network segment including inter-region routers to generate a second set of paths; and (c) the network segment including routers of the second region to generate a third set of paths; and
combining the first, second and third set of paths to provide a set of paths between the first router and the second router.

2. A method as in claim 1, wherein the path generation algorithm are applied to obtain the first, second and third sets of paths independently.

3. A method as in claim 1, wherein the automatic path generation algorithm comprises a breadth-first search.

4. A method as in claim 1, wherein the automatic path generation algorithm comprises a path evaluation algorithm based on cost constraints.

5. A method as in claim 4, wherein the cost constraints comprises one of bandwidth availability and utilization factor.

6. A method as in claim 4, wherein the path evaluation algorithm comprises the Dijstra algorithm.

7. A method as in claim 4, wherein the path evaluation algorithm comprises a radius based algorithm.

8. A method as in claim 1, further comprising assigning each router within each region a numerical rank according to a metric indicative of a distance between the router and an inter-region router within that region.

9. A method as in claim 8, wherein the metric is a hop count between the router and the inter-region router.

10. A method as in claim 9 wherein, when a path is required between routers of the same region, the method further comprises applying the automatic path generation algorithm on a network segment including only routers greater than or equal to a predetermined numerical rank.

11. A method as in claim 10, wherein the predetermined rank is one.

12. A method as in claim 8, wherein, when a new router is added into a region of the computer network, the numerical rank of each router within that region is re-assigned.

13. A system organized for optimizing the performance of an automatic path generation algorithm on a computer network, comprising:
a plurality of routers in the computer network configured into regions according to geographical locations, including inter-region routers in each region having an interface with a router of another region; and
a processor within the computer network capable of, when a path is required between a first router in a first region and a second router in a second region:
applying the automatic path generation algorithm to: (a) the network segment including routers in the first region to generate a first set of paths, (b) the network segment including inter-region routers to generate a second set of paths; and (c) the network segment including routers of the second region to generate a third set of paths; and
combining the first, second and third set of paths to provide a set of paths between the first router and the second router.

14. A system as in claim 13, wherein the plurality of routers comprises edge routers.

15. A system as in claim 13, wherein the automatic path generation algorithm comprises a breadth-first search.

16. A system as in claim 13, wherein the automatic path generation algorithm comprises a path evaluation algorithm based on cost constraints.

17. A system as in claim 16, wherein the cost constraints comprises one of bandwidth availability and utilization factor.

18. A system as in claim 16, wherein the path evaluation algorithm comprises the Dijstra algorithm.

19. A system as in claim 16, wherein the path evaluation algorithm comprises a radius based algorithm.

20. A system as in claim 13, wherein each router within each region is assigned each a numerical rank according to a metric indicative of a distance between the router and an inter-region router within that region.

21. A system as in claim 20, wherein the metric is a hop count between the router and the inter-region router.

22. A system as in claim 21 wherein the processor being further capable of, when a path is required between routers of the same region, applying the automatic path generation algorithm on a network segment including only routers greater than or equal to a predetermined numerical rank.

23. A system as in claim 20, wherein the predetermined rank is one.

24. A system as in claim 20, wherein the routers within a region is organized topologically as a tree structure.

25. A system as in claim 13, wherein the inter-region routers belong to a highly redundant, fully meshed network.
